(19) United States
(12) Patent Application Publication
(10) Pub. No.: US 2026/0287015 A1
(43) Pub. Date: Sep. 24, 2026

(54) SLIDE RAIL ASSEMBLY WITH BUFFER MECHANISM

(71) Applicant: Nan Juen International Co., Ltd., Taoyuan City (TW)

(72) Inventors: Kuo-Chin LAI, Taoyuan City (TW); Yu-Cheng LIN, Taoyuan City (TW)

(21) Appl. No.: 19/435,353

(22) Filed: Dec. 29, 2025

(30) Foreign Application Priority Data
Mar. 20, 2025 (TW) 114110906

(51) Int. Cl. F16C 29/02

(52) U.S. Cl. CPC F16C 29/02

(57) ABSTRACT

A slide rail assembly with buffer mechanism includes a first rail, a second rail with a first working feature at one end, and a buffer device set on the first rail. The buffer device includes a slider movably located on one side of the first rail with a second working feature and a third working feature set at both ends and a first elongated slot set therebetween, and a movable device installed in the first elongated slot. When the second rail extends out to a first distance, the first working feature drives the second working feature to move the slider in the same direction, so that the movable device generates a resistance. When the second rail retracts to a second distance, the first working feature drives the third working feature to move the slider in the same direction, so that the movable device generates a resistance.

### 1. FIELD OF THE INVENTION

The present invention relates to a slide rail assembly with buffer mechanism, especially suitable for racks and chassis of industrial servers, where when one slide rail is extended and retracted relative to another, the slide rails start to move to a certain distance without resistance, and then, a moving mechanism generates resistance to allow the slide rails to slowly move to the end of their stroke.

### 2. DESCRIPTION OF THE RELATED ART

In existing industrial server racks and chassis, the slide rail assembly typically consist of a first rail (e.g., the outer frame) and a second rail (e.g., the middle frame or the middle and inner frames). The first rail is installed on the rack, and the second rail is installed on the chassis. During the extending and retraction process of the second rail relative to the first rail, an elastic force is generated by the action of an elastic device, such as an elastic device composed of a spring. Before the second rail extends out and retracts to the end of its stroke, the elastic force of the elastic device causes a slow displacement stroke to the end. However, the aforementioned slow displacement method causes the second rail to repeatedly resist the elastic force of the elastic device at the moment of activation when it extends out and retracts relative to the first rail, meaning it also has a slow displacement stroke at activation, which can cause the user to apply excessive force to the chassis on the second rail, causing the second rail to detach from the first rail and the chassis to fall out of the cabinet. Therefore, how to solve the problem that the second fall, relative to the first fall, also has a slow displacement stroke at the moment of activation when it extends out and retracts is the direction that relevant operators in this industry urgently want to study and improve.

### SUMMARY OF THE INVENTION

The main object of the present invention is to provide a slide rail assembly with buffer mechanism, which comprises a slider and a movable device. When the second rail extends out, it moves in the same direction to a firs distance. Then, the first working feature of the second rail abuts against and drives the slider, causing the slider to move in the same direction, so that the movable device generates a resistance. When the second rail extends out and contracts, after it moves to a second distance in the same direction, the first working feature of the second rail abuts against and drives the slider, causing the slider to move in the same direction, so that the movable device generates a resistance.

To achieve the above object, the present invention employs a technical means comprising a first rail, a second rail, and a buffer device. The second rail can be displaced relative to the first rail. The second rail has a first working feature set at one end. The buffer device is located on the slider is movably positioned on one side of the first rail. one side of the first rail and comprises a slider and a movable device. The slider comprises a second working feature and a third working feature respectively located at two opposite ends, and a first elongated slot opened between the second working feature and the third working feature. The movable device is installed in the first elongated slot. Thus, when the second rail extends out to a first distance, the first working feature abuts against and drives the second working feature of the slider, causing the slider to displace in the same direction, so that the movable device generates a resistance. When the second rail retracts and displaces to a second distance, the first working feature abuts against and drives the third working feature of the slider, causing the slider to displace in the same direction, so that the movable device generates a resistance.

### BRIEF DESCRIPTION OF THE DRAWINGS

FIG. 1 is a schematic diagram of the slide rail assembly with buffer mechanism of the present invention.

FIG. 2 is an exploded view of the buffer device of the present invention.

FIG. 3 is another exploded view of the buffer device of the present invention.

FIG. 4 is a three-dimensional diagram of the slide rail assembly with buffer mechanism of the present invention in its closed position.

FIG. 5 is a schematic diagram of the second rail of the present invention retracted relative to the first rail.

FIG. 6 is a schematic diagram of the second rail of the present invention extended out at the first distance.

FIG. 7 is a schematic diagram of the second rail of the present invention extended out to the first working feature and abutted against the slider

FIG. 8 is a schematic diagram of the second rail of the present invention extended out to the end of its stroke.

FIG. 9 is another schematic diagram of the second rail of the present invention extended out to the end of its stroke.

FIG. 10 is a schematic diagram of the present invention when the second rail is retracted to the second distance.

FIG. 11 is a schematic diagram of the present invention when the second rail is retracted to the first working feature and abutted against the slider.

### DETAILED DESCRIPTION OF THE PREFERRED EMBODIMENT

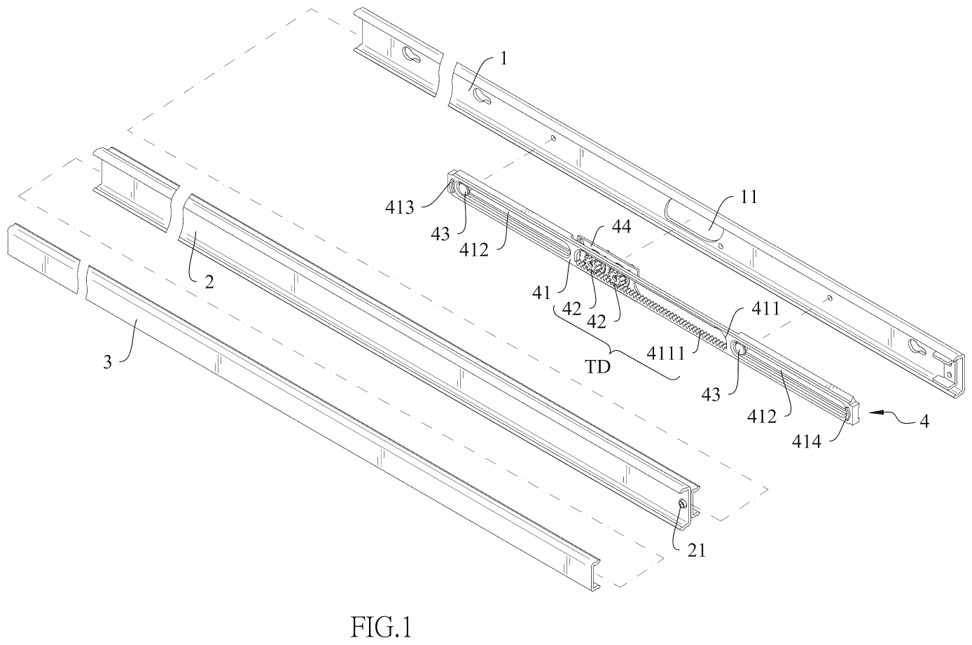

Please refer to FIG. 1. The present invention is a slide rail assembly with a buffer mechanism, comprising: a first rail 1, a second rail 2, a third rail 3, and a buffer device 4. The first rail 1 has a first mounting slot 11, and the second rail 2 can be displaced relative to the first rail 1. The second rail 2 has a first working feature 21 at one end, which faces the first rail 1. The third rail 3 can be displaced relative to the second rail 2. The second rail 2 is used to extend the displacement of the first rail 1 relative to the third rail 3, and the buffer device 4 is located on one side of the first rail 1.

The first working feature 21 of the present invention can be connected to one end of the second rail 2, and the first working feature 21 is a locking fastener, an elastic element, a hydraulic rod, a pneumatic rod, or any other block component with a blocking function. Furthermore, the first working feature 21 can also be a block structure, integrally formed at one end of the second rail 2, and has a blocking function. The present invention is illustrated using fasteners (e.g., rivets) as examples, but these examples are not intended to limit the scope of the present invention.

The structure, displacement, extending out and retracting of the first rail 1, second rail 2 and third rail 3 of the present invention are already known technologies and will not be described in detail here for the sake of simplicity.

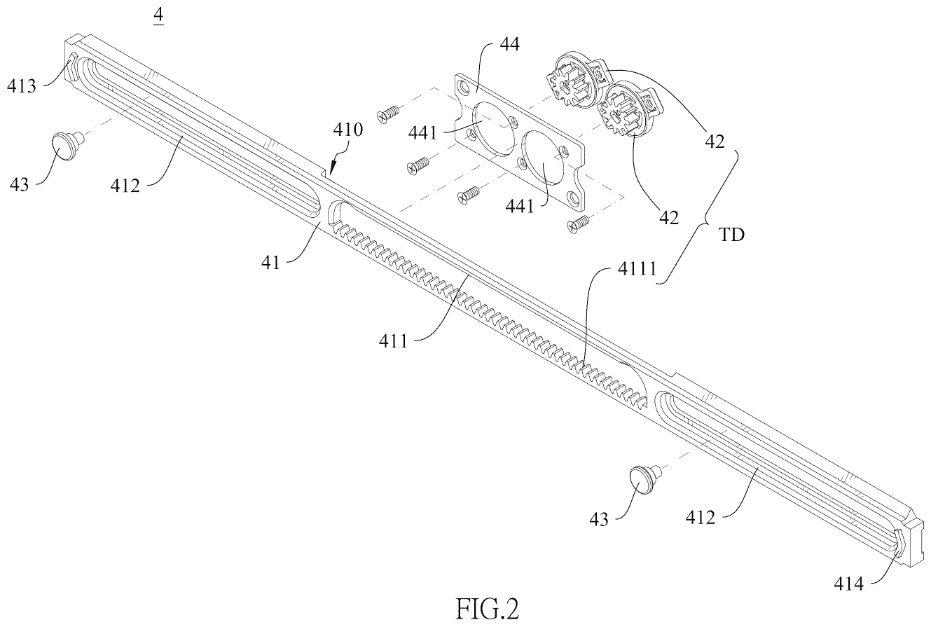

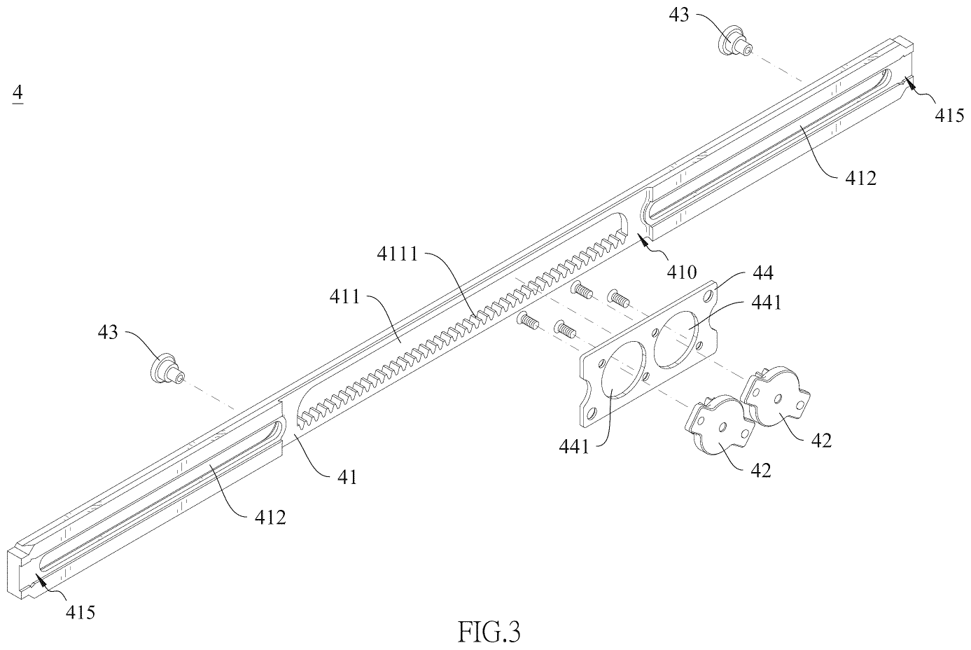

Please refer to FIGS. 1 to 3, where the buffer device 4 comprises: a slider 41, at least one movable member 42, at least one fixed member 43 (e.g., rivet) and a fixed plate 44. The slider 41 is movably positioned on one side of first rail 1. The slider 41 is shorter than the second rail 2. The slider 41 has a horizontally extending first elongated slot 411 and at least a second elongated slot 412 adjacent to the first elongated slot 411. The first elongated slot 411 has at least one side thereof provided with a horizontally extended guide feature 4111. The slider 41 has a second working feature 413 and a third working feature 414 respectively located at the two opposite ends thereof. The second working feature 413 and the third working feature 414 correspond to one side of the second rail 2, respectively. Furthermore, the first elongated slot 411 and the at least one second elongated slot 412 are respectively located between the second working feature 413 and the third working feature 414. The at least one movable member 42 corresponds to guide feature 4111, and the at least one movable member 42 and the guide feature 4111 constitute a movable device TD. The movable device TD is positioned within the first elongated slot 411 of the slider 41. The at least one fixed member 43 passes through the at least one second elongated slot 412 and then locked to one side of the first rail 1. The at least one movable member 42 is installed on the first rail 1. The fixed plate 44 has at least one second mounting slot 441 corresponding to the first mounting slot 11. The slider 41 has a first movable space 410 located on one side thereof adjacent to the first elongated slot 411 and connected to the first elongated slot 411. The fixed plate 44 is located within the first movable space 410. The at least one movable member 42 is mounted on the fixed plate 44 and positioned between the first mounting slot 11 and the first movable space 410.

The present invention is illustrated by using two movable members 42 and two second elongated slots 412 as an example. The number of movable member 42 and second elongated slot 412 may be one, three, four or five, respectively. This embodiment is not intended to limit the scope of the present invention.

The present invention allows the first working feature 21 to be integrally formed on the second rail 2 (e.g., by stamping), or to be manufactured separately and then assembled onto one end of the second rail 2. The present invention allows the second working feature 413 and the third working feature 414 to be separately manufactured and then separately overlaid and injection-cast onto both ends of the slider 41, or they can be integrally formed onto both ends of the slider 41 (e.g., manufactured by sheet metal stamping). The present invention is illustrated by the example of manufacturing the first working feature 21 and the second rail 2 separately and then assembling the first working feature 21 at one end of the second rail 2, and manufacturing the second working feature 413 and the third working feature 414 separately and then encapsulating and injecting them onto both ends of the slider 41. The examples are not intended to limit the scope of the present invention.

Continuing from the above, the first working feature 21 is preferably made of a non-plastic material, such as metal (iron); the second working feature 413 and the third working feature 414 are preferably made of a non-plastic material, such as metal; or one of the second working feature 413 and the third working feature 414 contains a plastic material, and the other of the second working feature 413 and the third working feature 414 contains a metal material, or alternatively, the second working feature 413 and the third working feature 414 could be made of plastic, which would be more suitable for different usage environments. As mentioned above, the first working feature 21 is preferably made of a non-plastic material, such as metal. The first working feature 21, second working feature 413 and third working feature 414 of the present invention are illustrated using metal as an example. The examples are not intended to limit the scope of the present invention.

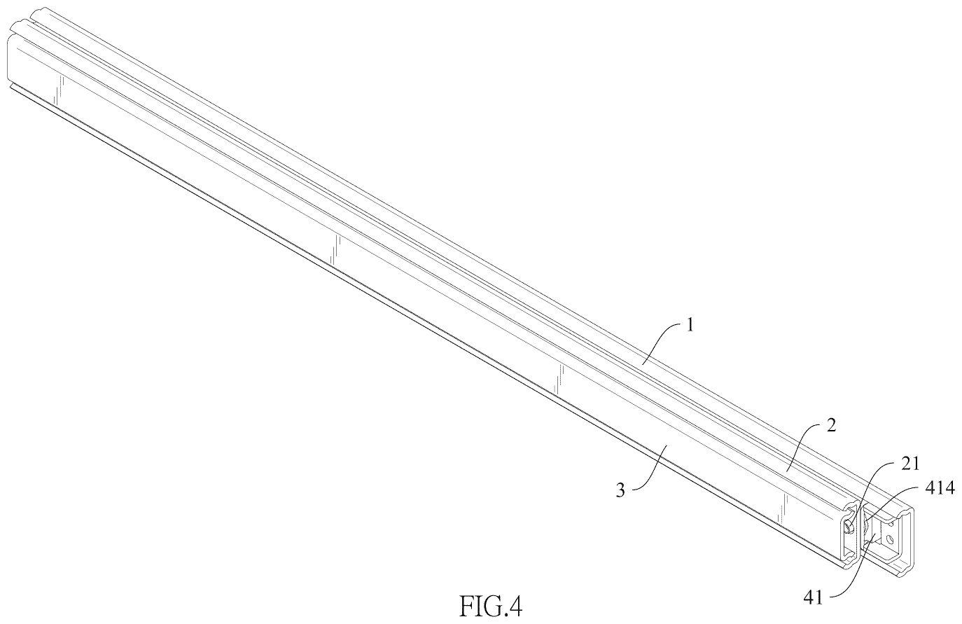

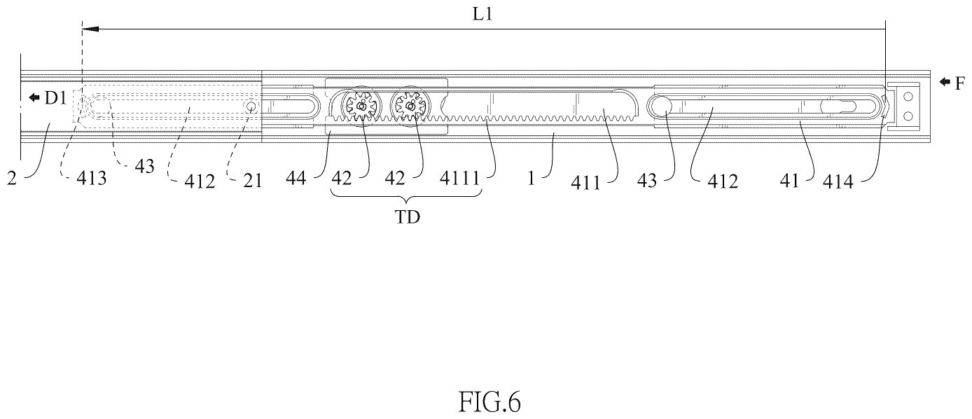

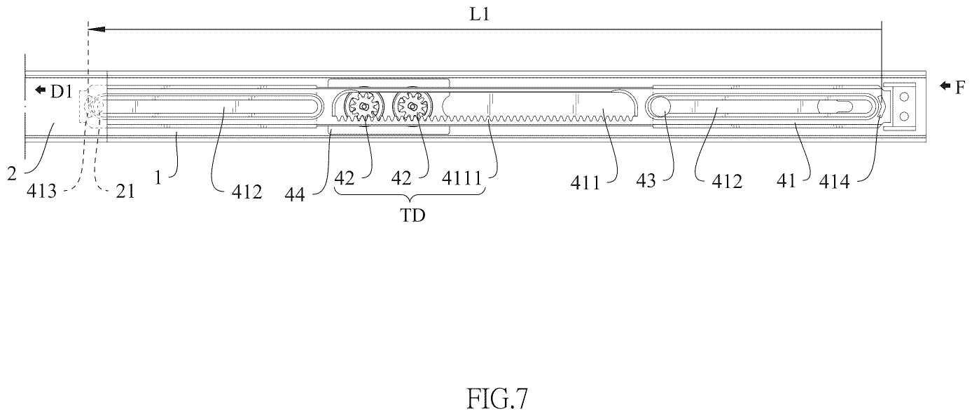

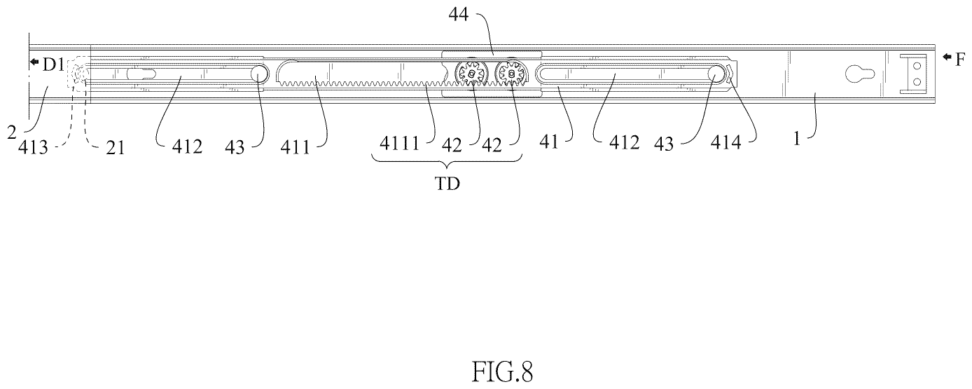

Please refer to FIGS. 4 through 9. When the second rail 2 is stretched under force, it displaces in the first direction D1, and the first working feature 21 of the second rail 2 separates from the third working feature 414 of the slider 41. After the second rail 2 moves in the same direction to a first distance L1, its first working feature 21 abuts against and drives the second working feature 413 of the slider 41, causing the slider 41 to move in the same direction. The first movable space 410 is used to make way for the fixed plate 44, and the movable device TD is activated. The guide feature 4111 of the first elongated slot 411 is driven by the slider 41. The guide feature 4111 pushes the at least one movable member 42 to rotate, generating a resistance. The slider 41 continues to move until the at least one fixed member 43 abuts against one end of the at least one second elongated slot 412, and one end of the fixed plate 44 abuts against one end of the first movable space 410. Then, the at least one fixed member 43 and the fixed plate 44 are used to limit the movement of the slider 41, so that second rail 2 extends out to the end of its stroke and stops moving.

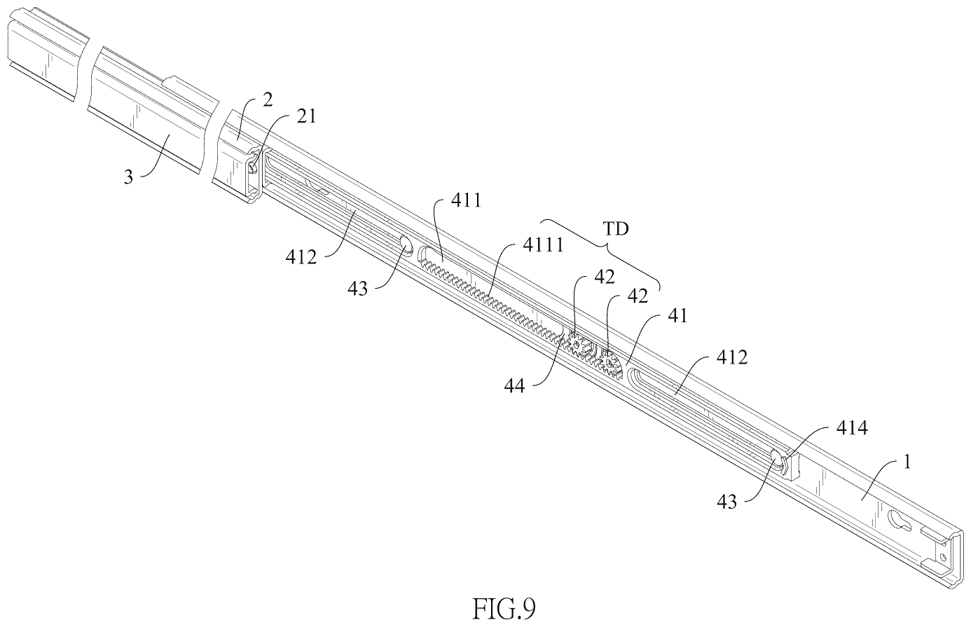

Please refer to FIG. 9. When the second rail 2 extends out relative to the first rail 1 to its end of stroke, the technician can understand that by using an anti-detachment component (not shown in the figure) located on the first rail 1, the second rail 2 can be stopped at the end of its stroke. Force can be applied to the anti-detachment component, which allows the second rail 2 to be disassembled relative to the first rail 1 at the end of its stroke or moved in the retracting direction. Furthermore, the second rail 2 is connected to a server chassis (not shown in the figure). When the server chassis is pulled out or pushed back, second rail 2 will move in tandem with the server chassis.

Continuing from the above, when the anti-detachment component fails, its fixed plate 44 can abut against the first movable space 410 to prevent the slider 41 from shifting in the first direction D1 and the second direction D2, thus preventing the server chassis located on the second rail 2 from accidentally detaching or retracting relative to the first rail 1. And the at least one fixed member 43 is used to prevent the slider 41 from swaying vertically to one side relative to the first rail 1.

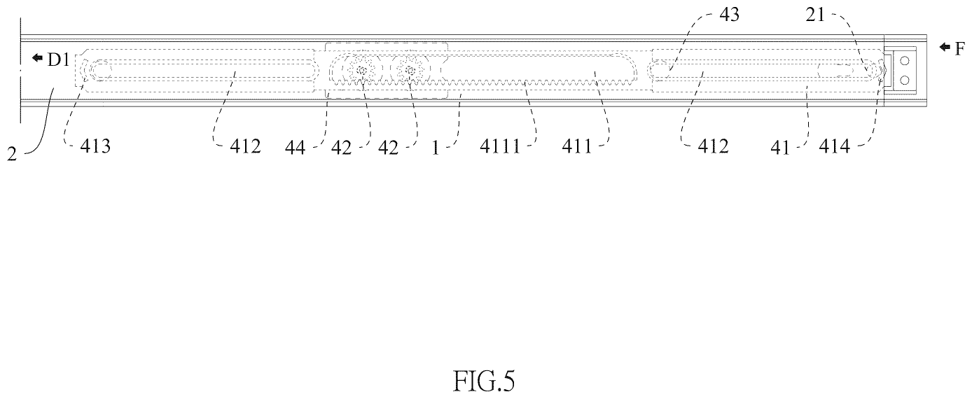

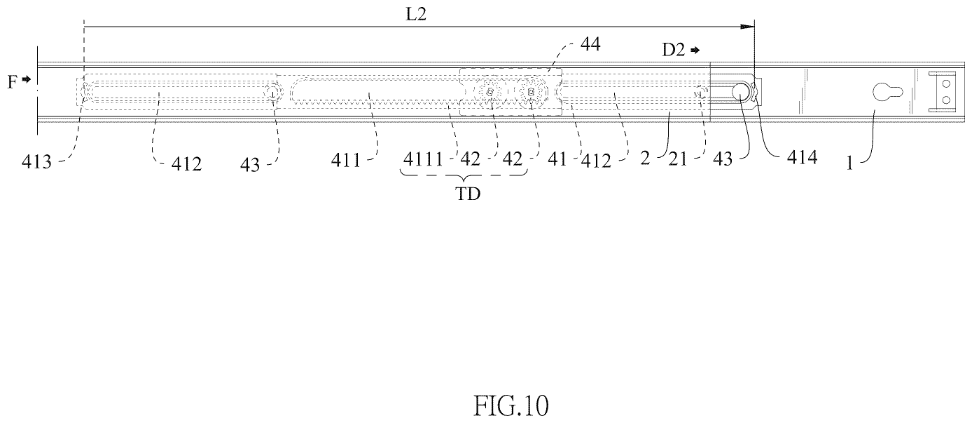

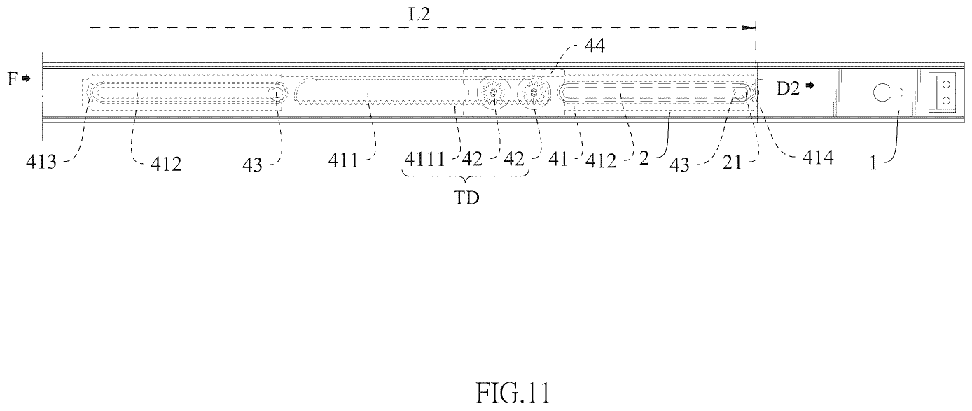

Please refer to FIGS. 5, 10, and 11. When the second rail 2 is subjected to force and retracts in the second direction D2, which is opposite to the first direction D1, the first working feature 21 of the second rail 2 detaches from the second working feature 413 of the slider 41. After the second rail 2 continues to move in the same direction to a second distance L2, the first working feature 21 of the second rail 2 abuts against and drives the third working feature 414 of the slider 41, causing the slider 41 to move in the same direction. The other actions are in the opposite direction to the above actions, and will not be described in detail here.

Continuing from the above, the at least one movable member 42 is a damping gear, and the guide feature 4111 is a rack integrally formed on the first elongated slot 411, with the damping gear meshing with the rack of the guide feature 4111. When the first working feature 21 abuts against and drives the second working feature 413 of the slider 41, causing the slider 41 to continue displacing in the same direction, its damping gear meshes with the rack, generating rotation and creating resistance. Furthermore, when the first working feature 21 abuts against and drives the third working feature 414 of the slider 41, causing the slider 41 to continue to move in the same direction, the rack of the guide feature 4111 is driven by the slider 41 and pushes the damping gear to rotate and generate resistance, so that the second rail 2 extends out relative to the first rail 1 to the end of its stroke.

In another embodiment of the present invention, the at least one movable member 42 is a rolling bearing (not shown in the figures), and the guide feature 4111 is a plurality of arcuate protrusions (not shown in the figures). The rolling bearing presses against the arcuate protrusions. The mating components, structure, and direction of movement are the same as described in the previous paragraph and will not be repeated here.

The buffer device 4 disclosed in the present invention comprises a slider 41 and a movable device TD. The slider 41 is movably positioned on one side of the first rail 1 and has a first elongated slot 411. The movable device TD is located in the first elongated slot 411. When the second rail 2 extends out and contracts, it moves in the same direction to a first distance L1 and a second distance L2, respectively. Then, the first working feature 21 of the second rail 2 comes into contact with the slider 41, and the first working feature 21 then drives the slider 41 to continue moving in the same direction. At this point, the movable device TD generates resistance, which allows the second rail 2 to extend out and retract to the end of its stroke. Thus, when the second rail 2 is extended out and retracted, its displacement in the same direction allows for an initiation displacement of the first distance L1 and the second distance L2 without resistance. Only after the second rail 2 has moved to the first distance L1 and the second distance L2 in the same direction will the movable device TD generate resistance.

The terms “installation,” “mounting,” and “connection” in the present invention's description and patent scope, as well as in the aforementioned drawings, should be interpreted broadly. For example, they can refer to a fixed connection, a detachable connection, or an integral connection; they can also refer to a mechanical connection. Those with ordinary knowledge in the relevant technical field can understand the specific meaning of the above terms in the present invention patent according to the specific circumstances.

The terms “first,” “second,” and “third” in the description of the present invention, the scope of the patent, and the accompanying drawings are used to distinguish similar objects and are not necessarily used to describe a specific order or sequence.

The description of the present invention, the scope of the invention patent, and the terms “upper,” “lower,” “left,” “right,” “front,” “back,” “top,” “bottom,” “inner,” and “outer” in the aforementioned drawings indicate the orientation or positional relationship based on the orientation or positional relationship shown in the drawings. These terms are primarily for the purpose of better describing the present invention and its embodiments, and are not intended to limit the indicated devices, elements or components to having a particular orientation, or to be constructed and operated in a particular orientation.

Furthermore, some of the terms mentioned above, besides indicating location or positional relationships, may also have other meanings. For example, the term “on” may, in some cases, indicate a relationship of dependence or connection. For those skilled in the art, the specific meaning of these terms in the present invention can be understood according to the specific circumstances.

What the invention claimed is:

1. A slide rail assembly with buffer mechanism, comprising:
a first rail;
a second rail movable relative to said first rail, said second rail comprising a first working feature located at one end thereof; and
a buffer device located on one side of said first rail, said buffer device comprising a slider and a movable device, said slider is movably positioned on one side of the first rail, said slider comprising a second working feature and a third working feature respectively located at two opposite ends thereof and a first elongated slot opened between said second working feature and said third working feature, said movable device is located in the first elongated slot;
wherein when said second rail extends out and displaces to a first distance, said first working feature abuts against said second working feature of said slider, causing said second working feature to displace and to drive said slider, so that said movable device generates a resistance; when said second rail retracts and displaces to a second distance, said first working feature abuts against said third working feature of said slider and causes said third working feature to displace and to move said slider, so that said movable device generates a resistance.

2. The slide rail assembly with buffer mechanism as claimed in claim 1, wherein said movable device comprising at least one movable member and a guide feature, said guide feature extending horizontally on at least one side of said first elongated slot, said at least one movable member being set on said first rail and corresponding to said guide feature.

3. The slide rail assembly with buffer mechanism as claimed in claim 2, wherein said guide feature that extends horizontally on at least one side of said first elongated slot is capable of driving said at least one movable member to generate a resistance.

4. The slide rail assembly with buffer mechanism as claimed in claim 2, wherein said first rail comprises a first mounting slot; said slider further comprises a first movable space located on one side thereof adjacent to said first rail and connected to said first elongated slot; said buffer device further comprises a fixed plate located within said first movable space and corresponding to said first mounting slot; said at least one movable member is mounted on said fixed plate, and is inserted into said first elongated slot from said first movable space.

5. The slide rail assembly with buffer mechanism as claimed in claim 2, wherein said at least one movable member each is a damping gear, and said guide feature is a rack meshed with each said damping gear.

6. The slide rail assembly with buffer mechanism as claimed in claim 2, wherein said guide feature is composed of a plurality of arcuate protrusions; said at least one movable member each is a rolling bearing pressing against said arcuate protrusions.

7. The slide rail assembly with buffer mechanism as claimed in claim 1, wherein said slider has two opposite ends thereof respectively connected to said second working feature and said third working feature, and said second working feature and said third working feature are respectively aligned with said first working feature.

8. The slide rail assembly with buffer mechanism as claimed in claim 4, wherein said slider of said buffer device further comprises at least one horizontally extending second elongated slot adjacent to said first elongated slot; said buffer device further comprises at least one fixed member passing through said at least one second elongated slot and then locked to one side of said first rail, said at least one fixed member abutting against two opposite ends of said at least one second elongated slot to limit the movement of said slider.

9. The slide rail assembly with buffer mechanism as claimed in claim 7, wherein said first working feature selectively comprises at least a locking fastener, a spring, a hydraulic rod, or a pneumatic rod.
